(19) United States
(12) Patent Application Publication
(10) Pub. No.: US 2026/0261435 A1
(43) Pub. Date: Sep. 3, 2026

(54) METHOD AND SYSTEM FOR AUTOMATING ROTATION OF DIGITAL CERTIFICATE IN CLOUD-NATIVE ENVIRONMENT USING SERVERLESS FUNCTION

(71) Applicant: JPMorgan Chase Bank, N.A., New York, NY (US)

(72) Inventors: Dipankar CHOWDHURY, Mumbai (IN); Ashutosh PAREEK, Mumbai (IN)

(73) Assignee: JPMorgan Chase Bank, N.A., New York, NY (US)

(21) Appl. No.: 19/179,498

(22) Filed: Apr. 15, 2025

(30) Foreign Application Priority Data
Feb. 28, 2025 (IN) 202511017932

(51) Int. Cl. H04L 9/32; H04L 9/08

(52) U.S. Cl. CPC H04L 9/3263; H04L 9/0825; H04L 9/3247

(57) ABSTRACT

An aspect of the present disclosure relates to a method and system for automating rotation of a digital certificate in a cloud-native environment using a serverless function is disclosed. The method includes generating a certificate signing request and an associated private key. The method further includes transmitting the certificate signing request to a Certificate Authority (CA) for issuing the digital certificate. The method includes retrieving the issued digital certificate from the CA based on the certificate signing request. The method includes storing the issued digital certificate and the associated private key tagged with a stage identifier at a secure vault. In addition, the method includes uploading the issued digital certificate on a server for performing a connectivity test using the associated private key. The method also includes updating the stage identifier for the issued digital certificate and the associated private key based on a successful connectivity test.

### CROSS-REFERENCE TO RELATED APPLICATIONS

This application claims priority benefit from Indian Application No. 202511017932, filed on February 28, 2025, in the India Patent Office, which is hereby incorporated by reference in its entirety.

### FIELD OF THE DISCLOSURE

This technology generally relates to secure management and automation of digital certificates in cloud-native environments, and more particularly relates to a method and a system for automating rotation of a digital certificate in a cloud-native environment using a serverless function.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In modern business environments, secure and efficient communication between business partners, whether internal or external, is essential. Many organizations, including financial institutions, rely on application programming interfaces (APIs’) (such as File Transfer APIs) to facilitate these secure communications. A secure communication through the APIs requires authentication for security, ensuring that communications are directed to valid users in a secured way. The purpose of API authentication and authorization is to ensure that only authorized users or applications are able to access the API and the resources it provides. This helps to protect sensitive data. An example of one such communication may be a file transfer operation. For this, the APIs may be protected through authentication methods such as certificate-based authentication and OAuth. The certificate-based authentication uses a digital certificate to authenticate the identity of a user or client connecting to the API. The digital certificate is a document that is used to verify identity of an entity or a user. In other words, the digital certificate is a file that proves the authenticity of a device, server, or user through the use of public key infrastructure (PKI). The OAuth authentication is an open standard for authorization, commonly used to allow third-party applications to access resources without sharing user credentials. OAuth uses tokens (usually access tokens) to grant access to APIs on behalf of a user or service.

Further, for each business partner involved in file transfer, a unique certificate is required. This results in the need for multiple certificates when a business application communicates with various business partners. For example, if a business application needs to transfer files to 10 different partners, it will require 10 separate certificates. This number may increase exponentially as the number of partners or communication destinations grows, which is a common scenario in large-scale organizations. The management of these certificates involves a lot of human involvement starting from generating a certificate signing request and a private key to obtaining the certificate from a certificate authority and then testing and storing the certificate securely in a vault. All these steps are performed manually and are repeated annually to ensure that the certificates remain valid and do not expire, leading to a repetitive and time-consuming process.

The complexity and frequency of these steps increase significantly when a business application is required to manage numerous certificates. For example, in cases where the business application is tasked with managing 30+ certificates for multiple partners, it becomes virtually impossible to manually oversee each certificate’s lifecycle. Additionally, human involvement increases the likelihood of errors, such as misconfiguration, missed renewal deadlines, or incorrect certificate assignment. Furthermore, storing and handling private keys manually presents a potential security risk, as unauthorized access to private keys may compromise the integrity of the entire system.

The continued reliance on manual certificate management is a significant challenge for enterprises that rely heavily on secure communication protocols, such as those used for client-server interactions across business applications.

Hence, in view of these and other existing limitations, there arises an imperative need to provide an efficient solution to overcome the above-mentioned limitations and to provide a method and system that automates rotation of certificates/digital certificates in cloud native environments.

### SUMMARY

The present disclosure, through one or more of its various aspects, embodiments, and/or specific features or sub-components, provides, inter alia, various systems, servers, devices, methods, media, programs, and platforms for automating rotation of a digital certificate in a cloud-native environment using a serverless function.

According to an aspect of the present disclosure, a method for automating rotation of a digital certificate in a cloud-native environment using a serverless function is disclosed. The method may include generating a certificate signing request and an associated private key. The method may also include transmitting the certificate signing request (CSR) to a Certificate Authority (CA) for issuing the digital certificate associated with the certificate signing request. Next, the method may include retrieving the issued digital certificate from the CA based on the CSR. The method may further include storing the issued digital certificate and the associated private key tagged with a stage identifier in a secure vault. In addition, the method may include uploading the issued digital certificate on a server for performing a connectivity test using the associated private key. Also, the method may include updating the stage identifier for the issued digital certificate and the associated private key based on a successful connectivity test.

In accordance with an exemplary embodiment, the serverless function may be triggered based on a preconfigured rotation schedule and an on-demand request.

In accordance with an exemplary embodiment, an acknowledgment may be received from the server upon successful uploading of the issued digital certificate.

In accordance with an exemplary embodiment, the issued digital certificate may be uploaded on the server using a REST API.

In accordance with an exemplary embodiment, the issued digital certificate and the private key stored in the secure vault may be tagged with the stage identifier defined with a pending stage.

In accordance with an exemplary embodiment, based on the successful connectivity test, the stage identifier of the issued digital certificate and the associated private key stored in the secure vault may be updated from a pending stage to a current stage and the stage identifier of an existing digital certificate and an existing associated private key stored in the secure vault may be updated from a current stage to a previous stage.

In accordance with an exemplary embodiment, the successful connectivity test includes receiving a status code from the server to ensure that the issued digital certificate and the associated private key are working correctly.

According to another aspect of the present disclosure, a computing device configured to execute a method for automating rotation of a digital certificate in a cloud-native environment is disclosed. The computing device includes a processor; a memory storing instructions; and a communication interface coupled to each of the processor and the memory. The processor may be programmed to cooperate with the instructions to perform operations including: generate a certificate signing request and an associated private key; transmit the certificate signing request to a Certificate Authority (CA) for issuing the digital certificate associated with the certificate signing request; retrieve the issued digital certificate from the CA based on the certificate signing request; store the digital certificate and the associated private key tagged with a stage identifier in a secure vault; and upload the issued digital certificate on a server for performing a connectivity test using the associated private key and update the stage identifier for the issued digital certificate and the associated private key based on a successful connectivity test.

In accordance with an exemplary embodiment, the serverless function may be triggered based on a preconfigured rotation schedule and an on-demand request.

In accordance with an exemplary embodiment, an acknowledgment may be received from the server upon successful uploading of the issued digital certificate.

In accordance with an exemplary embodiment, the issued digital certificate may be uploaded on the server using a REST API.

In accordance with an exemplary embodiment, the issued digital certificate and the associated private key that may be stored in the secure vault may be tagged with the stage identifier defined with a pending stage.

In accordance with an exemplary embodiment, based on the successful connectivity test, the stage identifier of the issued digital certificate and the associated private key stored in the secure vault may be updated from a pending stage to a current stage and the stage identifier of an existing digital certificate and an existing associated private key stored in the secure vault may be updated from a current stage to a previous stage.

In accordance with an exemplary embodiment, the successful connectivity test includes receiving a status code from the server to ensure that the issued digital certificate and the associated private key are working correctly.

According to yet another aspect of the present disclosure, a non-transitory computer-readable storage medium storing instructions for automating rotation of a digital certificate in a cloud-native environment using a serverless function is disclosed. The storage medium stores instructions that include a set of executable code which, when executed by a processor, may cause the processor to perform operations including: generate a certificate signing request (CSR) and an associated private key; transmit the CSR to a Certificate Authority (CA) for issuing the digital certificate associated with the document signing request; retrieve the issued digital certificate from the CA based on the CSR; store the issued digital certificate and the associated private key tagged with a stage identifier at a secure vault; upload the issued digital certificate on a server for performing a connectivity test using the associated private key; and update the stage identifier for the issued digital certificate and the associated private key based on a successful connectivity test.

In accordance with an exemplary embodiment, the serverless function may be triggered based on a preconfigured rotation schedule and an on-demand request.

In accordance with an exemplary embodiment, an acknowledgment may be received from the server upon successful uploading of the issued digital certificate.

In accordance with an exemplary embodiment, the issued digital certificate may be uploaded on the server using a REST API.

In accordance with an exemplary embodiment, the issued digital certificate and the associated private key stored in the secure vault may be tagged with the stage identifier defined with a pending stage.

In accordance with an exemplary embodiment, based on the successful connectivity test, the stage identifier of the issued digital certificate and the associated private key stored in the secure vault may be updated from a pending stage to a current stage and the stage identifier of an existing digital certificate and an existing associated private key stored in the secure vault may be updated from a current stage to a previous stage.

In accordance with an exemplary embodiment, the successful connectivity test may include receiving a status code from the server to ensure that the issued digital certificate and the associated private key are working correctly.

### BRIEF DESCRIPTION OF THE DRAWINGS

The present disclosure is further described in the detailed description which follows, about the noted plurality of drawings, by way of non-limiting examples of exemplary embodiments of the present disclosure, in which characters represent like elements throughout the several views of the drawings.

FIG. 1 illustrates an exemplary computer system for implementing a method for automating rotation of a digital certificate in a cloud-native environment using a serverless function, in accordance with an exemplary embodiment.

FIG. 2 illustrates an exemplary diagram of a network environment with a device for automating rotation of the digital certificate in the cloud-native environment using the serverless function, in accordance with an exemplary embodiment.

FIG. 3 illustrates an exemplary system diagram for implementing a method for automating rotation of the digital certificate in the cloud-native environment using the serverless function, in accordance with an exemplary embodiment.

FIG. 4 illustrates an exemplary method flow diagram of a process for automating rotation of the digital certificate in the cloud-native environment using the serverless function, in accordance with an exemplary embodiment.

FIG. 5 illustrates a sequence diagram of an exemplary system for automating rotation of the digital certificate in the cloud-native environment using the serverless function, in accordance with an exemplary embodiment of the present disclosure.

FIG. 6 shows an implementation of rotation of a certificate from pending stage to current stage to previous stage.

### DETAILED DESCRIPTION

Exemplary embodiments will now be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it may be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms may be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may include within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

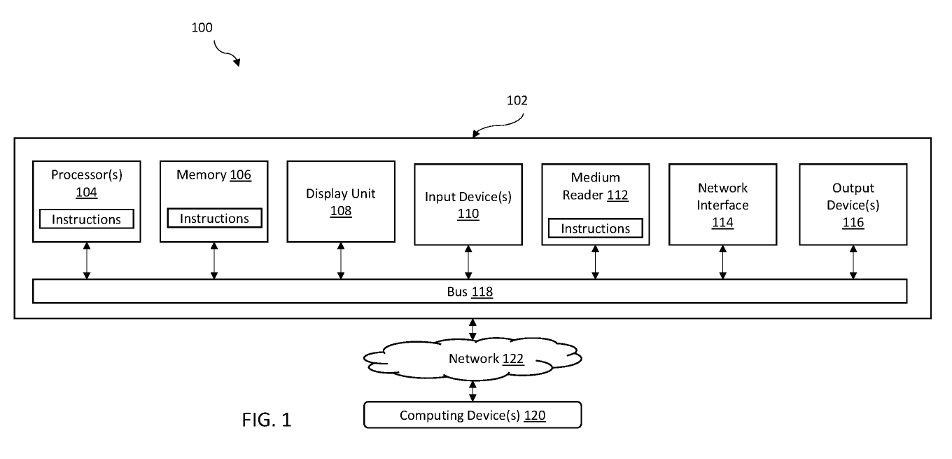

FIG. 1 is an exemplary system 100 for use in accordance with the embodiments described herein. The exemplary system 100 is generally shown and may include a computer system 102 which is generally indicated. The term “computer system” may also be referred to as “computing device” and such phrases/terms may be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that may store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may include any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms may be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations may include distributed processing, component/object distributed processing, and parallel processing. Virtual computer system processing may be constructed to implement one or more of the methods or functionalities as described herein, and a processor 104 described herein may be used to support a virtual processing environment.

As described herein, various embodiments provide methods and systems to automate rotation of the digital certificate in the cloud-native environment.

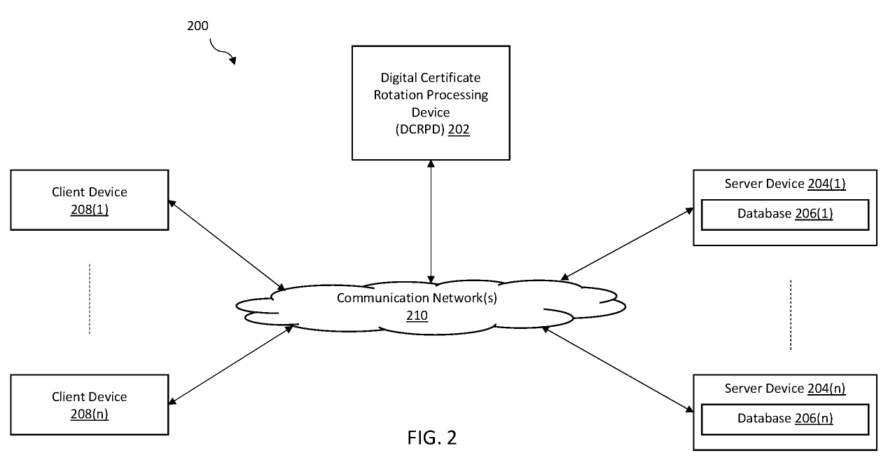

Referring to FIG. 2, a schematic diagram of an exemplary network environment 200 to automate rotation of a digital certificate in a cloud-native environment using a serverless function is illustrated. In an exemplary embodiment, the method is executable on any networked computer platform, such as, for example, a personal computer (PC).

The method to automate rotation of a digital certificate in a cloud-native environment using a serverless function may be executed by a digital certificate rotation processing device (DCRPD) 202. The DCRPD 202 may be the same or similar to the computer system 102 as described with respect to FIG. 1. The DCRPD 202 may store one or more applications that may include executable instructions that, when executed by the DCRPD 202, cause the DCRPD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the DCRPD 202 itself, may be located in the virtual server(s) running in a cloud-based computing environment rather than being tied to one or more specific physical network computing devices. Also, the application(s) may be running in one or more virtual machines (VMs) executing on the DCRPD 202. Additionally, in one or more embodiments of this technology, virtual machine(s) running on the DCRPD 202 may be managed or supervised by a hypervisor.

In the network environment 200 of FIG. 2, the DCRPD 202 is coupled to a plurality of server devices 204(1)-204(n) that host a plurality of databases 206(1)-206(n), and also to a plurality of client devices 208(1)-208(n) via communication network(s) 210. A communication interface of the DCRPD 202, such as the network interface 114 of the computer system 102 of FIG. 1, operatively couples and communicates between the DCRPD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DCRPD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and DCRPDs that efficiently implement the method to automate rotation of the digital certificate in the cloud-native environment using the serverless function.

By way of example only, the communication network(s) 210 may include local area network(s) (LAN(s)) or wide area network(s) (WAN(s)) and may use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), public switched telephone networks (PSTNs), ethernet-based packet data networks (PDNs), combinations thereof, and the like.

The DCRPD 202 may be a standalone device or integrated with one or more other devices or apparatuses, such as one or more of the server devices 204(1)-204(n), for example. In one particular example, the DCRPD 202 may include or be hosted by one of the server devices 204(1)-204(n), and other arrangements are also possible. Moreover, one or more of the devices of the DCRPD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the DCRPD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store data related to a rotation schedule, digital certificate, stage identifier, etc.

Although the server devices 204(1)-204(n) are illustrated as single devices, one or more actions of each of the server devices 204(1)-204(n) may be distributed across one or more distinct network computing devices that together include one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DCRPD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the DCRPD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the DCRPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DCRPD 202, the server devices 204(1)-204(n), or the client devices 208(1)-208(n), for example, may be configured to operate as virtual instances on the same physical machine. In other words, one or more of the DCRPD 202, the server devices 204(1)-204(n), or the client devices 208(1)-208(n) may operate on the same physical device rather than as separate devices communicating through communication network(s) 210. Additionally, there may be more or fewer DCRPDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, packet data networks (PDNs), the Internet, intranets, and combinations thereof.

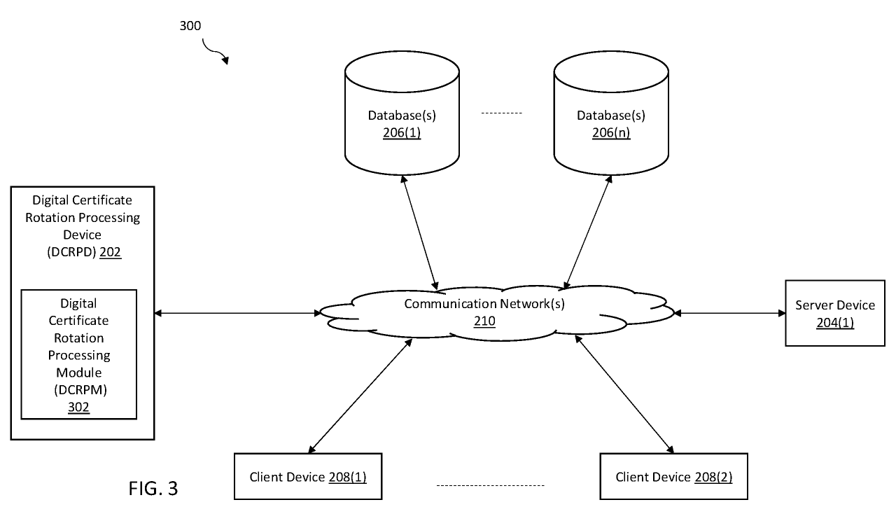

FIG. 3 illustrates an exemplary system 300 to automate a digital certificate in a cloud-native environment, in accordance with an exemplary embodiment. As illustrated in FIG. 3, according to exemplary embodiments, the system 300 may include a digital certificate rotation processing device (DCRPD) 202 including a digital certificate rotation processing module (DCRPM) 302 that may be connected to a server device 204(1) and one or more repository from the repositories 206(1) … 206(n) via a communication network 210, but the disclosure is not limited thereto.

The DCRPD 202 as described and shown in FIG. 3 includes the DCRPM 302, although it may include other rules, policies, modules, databases, or applications, for example. As will be described below, the DCRPM 302 is configured to carry out a method to automate rotation of a digital certificate in a cloud-native environment using a serverless function.

An exemplary system 300 for enabling a mechanism to automate rotation of a digital certificate in a cloud-native environment using a serverless function of FIG. 2 is shown as being executed in FIG. 3. Specifically, a first client device 208(1) and a second client device 208(2) are illustrated as being in communication with the DCRPD 202. In this regard, the first client device 208(1) and the second client device 208(2) may be “clients” of the DCRPD 202 and are described herein as such. Nevertheless, it is to be known and understood that the first client device 208(1) and/or the second client device 208(2) need not necessarily be “clients” of the DCRPD 202, or any entity described in association therewith herein. Any additional or alternative relationship may exist between either or both of the first client device 208(1) and the second client device 208(2) and the DCRPD 202, or no relationship may exist.

Further, the DCRPD 202 is illustrated as being able to access one or more repositories 206(1) ... 206(n). The DCRPM 302 may be configured to access these repositories/databases to provide a method to automate rotation of a digital certificate in a cloud-native environment using a serverless function.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may include plural networks as described above. For example, in an exemplary embodiment, either or both the first client device 208(1) and the second client device 208(2) may communicate with the DCRPD 202 via broadband or cellular communication. These embodiments are merely exemplary and are not limiting or exhaustive.

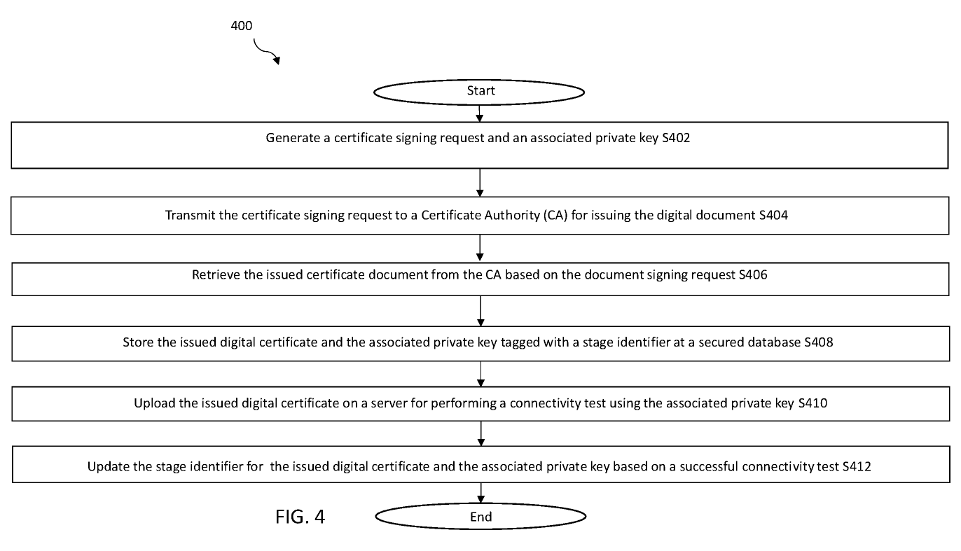

Referring to FIG. 4, an exemplary method 400 is shown for automating rotation of a digital certificate, in accordance with an exemplary embodiment. In particular, the exemplary method 400 is shown for automating rotation of the digital certificate in a cloud-native environment using a serverless function. The digital certificate is any electronic file or data structure that may be signed, encrypted or verified in a digital format. In addition, the digital certificate can be any signed or encrypted file that requires periodic rotation. The periodic rotation herein refers to as renewal or replacement.

The digital certificate is a file or electronic password that proves the authenticity of a device, server, or user using cryptography and a public key infrastructure (PKI). In an exemplary implementation, the digital certificate may be a client authentication certificate used in any enterprise system. The client authentication certificate may be used to authenticate an individual or machine attempting to access a secure network or system, often in conjunction with a Virtual Private Network (VPN) or other corporate systems. For example, an employee may use a client authentication certificate to log into an enterprise VPN. The client authentication certificate may serve as a proof that the employee’s device is authorized to access corporate network. When the employee connects to the VPN, the employee’s device presents the client authentication certificate, which is verified by the VPN server. The digital certificate has a validity of certain days and expires after that validity. For example, if a certain digital certificate has a validity of 365 days, it will expire after 365 days. The digital certificate needs to be renewed/rotated before the expiry of 365 days. The validity of the digital certificate is not limited to 365 days and may vary.

As shown in FIG. 4, the method 400 begins following a need to automate rotation of the digital certificate in the cloud-native environment using the serverless function. The cloud-native environment may refer to an infrastructure that is specifically designed to leverage cloud computing technologies and services. In this case, the cloud-native environment may be designed to support operations that automate rotation of the digital certificate, like the use of the serverless function. The cloud-native environment may provide infrastructure and services such as storage, databases, and the like required to execute the method 400 efficiently. In an embodiment, the serverless function may be present in the cloud-native environment. Further, the serverless function may be a computing model where individual units of work (functions) are triggered by events, without a need for users or developers to manage server infrastructure. The serverless functions are generally scalable, cost-effective, and event driven. The event driven serverless function may be a function that is triggered automatically by specific events such as time-based events or status updates as configured in the cloud-native environment. In an exemplary implementation, the serverless function may get triggered based on one action from among a preconfigured rotation schedule and an on-demand request. The preconfigured rotation schedule may be set up to ensure that the serverless function runs at specific times, ensuring timely rotation of the digital certificate (such as periodic certificate renewal). In an example, the on-demand request may be raised anytime by any user.

The method 400 is implemented by at least one processor 104. In an exemplary implementation, the method 400 may be performed by an exemplary system (herein after system) that may be a computing device 100 of FIG. 1.

At step S402, the method 400 may include generating a certificate signing request (CSR) and an associated private key. The CSR may include a set of details such as metadata, and information about an Applicant or an Organization signing the request. Inputs to create CSR may be in the form of an application form that includes various fields such as Common Name (CN), Organization Name (O), email Id, purpose of the certificate, validity period, etc. which are entered by a user of the Organization or the Applicant. The CSR may be generated to initiate obtaining a valid digital signature from a trusted entity such as a Certificate Authority (CA). The certificate authority may be located on premises of the Applicant or the Organization implementing the serverless function or it may be a third party associated with the Applicant/Organization. The CSR is generated by the serverless function.

At step S404, the method 400 may include transmitting the CSR to the CA for issuing the digital certificate associated with the CSR. In an exemplary implementation, the serverless function may connect with the CA via OAuth authentication to receive the digital certificate signed by the CA. An API endpoint may be used by the serverless function to connect to CA to fetch the digital certificate signed by the CA and its Oauth configuration details. The CA may be a trusted third-party entity responsible for issuing the digital certificate by verifying identity of the Applicant/requester and signing the digital certificate to generate a signed digital certificate. The OAuth configuration details associated with the digital certificate may include how the digital certificate may be used to authenticate the client or server, and ensure a secure communication between the components of the OAuth system. Digital certificates may be used for securing communication and ensuring the identity of the parties involved in OAuth transactions, such as the client, authorization server, or resource server. In an embodiment, the CA may issue the digital certificate to verify identity of the Applicant or the Organization’s user. In addition, the CA may issue the digital certificate with an expiration date, after which the digital certificate is no longer valid.

At step S406, the method 400 may include retrieving the issued digital certificate from the CA based on the CSR. The serverless function may be configured to retrieve the issued digital certificate from the CA once it has been issued by the CA.

At step S408, the method 400 may include storing the issued digital certificate and the associated private key tagged with a stage identifier in a secure vault using a secretID. This means that once the digital certificate is retrieved from the CA, the serverless function may get configured to store the issued digital certificate and the associated private key tagged with the stage identifier as “pending” in the secure vault. The secure vault may be an encrypted storage system used to store sensitive information such as digital certificates, private keys, and the like. In an example, the secure vault being cloud-native may be implemented by “AWS Secrets Manager” or “Azure Key Vault”. The “Azure Key Vault” is a cloud service (owned by “Microsoft”) or “AWS Secrets Manager” is a cloud service (owned by “Amazon”) for securely storing and accessing secrets. A secret may be anything that a user may need to tightly control access to, such as API keys, passwords, certificates, or cryptographic keys. It may store sensitive information such as: API keys, database credentials, private keys (like the private key associated with a digital certificate), passwords and configuration information. The secrets may be defined with secretIDs, where each secretID may be associated with a pair of digital certificate and the associated private key.

The stage identifier may be used to track and manage the lifecycle of the digital certificate and the associated private key. The stage identifier may allow the serverless function to determine where in the lifecycle, the digital certificate currently stands (e.g., “pending”, “current”, “previous”, etc.). In an exemplary implementation, the serverless function may utilize the stage identifier to update the stage of the digital certificate throughout its lifecycle. After the digital certificate is obtained from the CA, it may be stored in the secure vault along with the associated private key tagged with the stage identifier defined with a “pending” stage. In other words, when the issued digital certificate and the associated private key are first stored in the secure vault, they may be marked with a “pending” stage which may indicate that the issued digital certificate has not yet been validated (i.e., a connectivity test has not yet been performed for it to verify if the issued digital certificate and the associated private key are working properly). In an exemplary implementation, the “current” stage identifier may specify that the issued digital certificate and its associated private key have been tested and verified, and they are ready to be used for authentication. When a request for retrieving a digital certificate is received, the secure vault may always return the secretID associated with the certificate tagged with the “current” stage identifier. The “pending” stage identifier may describe a stage when a new certificate has been issued and stored in the secure vault, but it is still not ready to be used. Hence, it may be marked as “pending” which after successful connectivity test will be changed to “current” stage. When the “pending” stage identifier of the issued certificate is moved to the “current” stage identifier, the “current” stage identifier associated with an existing version of the digital certificate may be moved to “previous” stage identifier. This existing digital certificate may identify the previous version of the certificate stored in the secure vault.

At step S410, the method 400 may include uploading the issued digital certificate on a server using an API endpoint for the server for performing a connectivity test using the associated private key. The API endpoint for server may be an endpoint exposed by the server. In an example, the connectivity test may be performed to verify interaction between the issued digital certificate, the private key, and the server. The issued digital certificate may be uploaded on the server using an API. In an example, the API may be a REST API. The REST API may refer to the Representational State Transfer Application Programming Interface. The REST API may allow the digital certificate to be uploaded in a standardized manner, using HTTP methods such as POST or PUT, ensuring that the issued digital certificate and the associated private key are transferred correctly. Further, an acknowledgment may be received from the server upon successful uploading of the issued digital certificate. In an implementation, the serverless function may receive the acknowledgement from the server in real time.

At step S412, the method 400 may include updating the stage identifier for the issued digital certificate and the associated private key based on a successful connectivity test. The stage identifier associated with the issued digital certificate and the private key stored in the secure vault may be updated to a “current” stage based on the successful connectivity test. This may indicate that the digital certificate is now active, verified, and ready for use. The successful connectivity test may include receiving a status code from the server which denotes that the digital certificate and the associated private key are working correctly. In an embodiment, the connectivity test may include listing of files on the server. Further, the connectivity to the server may be established through a certificate-protected API which may expose an API endpoint (e.g., health check endpoint) that returns a 200 HTTP status code when the connectivity to the server has been successful. For example, once the connectivity to the server has been successfully established and the issued digital certificate is uploaded to the server, the health check endpoint may transmit a 200HTTP status code to the serverless function to denote that the issued digital certificate and the associated private key are working properly.

The method 400 may further include updating the stage identifier of an existing digital certificate and an existing associated private key to a “previous” stage. The existing digital certificate and the existing associated private key may describe the previous version of the issued digital certificate and the associated private key. The method 400 may maintain previous versions of the issued digital certificate and the associated private key for reference and audit purposes. Certificates with a “previous” designation are retired from use and may not work if there is an attempt to use them.

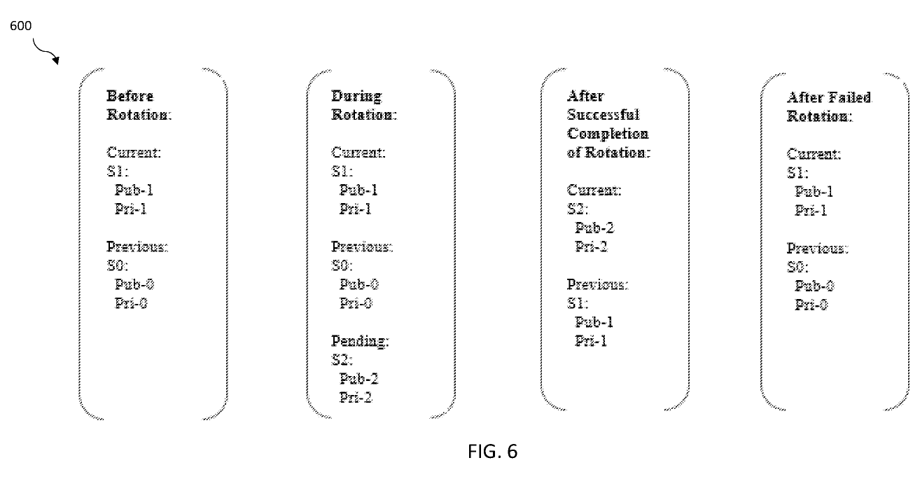

In an exemplary implementation, an example may now illustrate the working of method 400 as described above. Let us consider that the secure vault stores a secretID ‘S1’ associated with a digital certificate Pub-1 and its associated private key Pri-1 with “current” stage identifier. The secretID ‘S1’ with the “current” stage associated with the certificate pair (Pub-1, Pri-1) may be returned by secure vault whenever there is a request for a digital certificate. The previous version of the certificate pair (Pub-1, Pri-1) may also be stored in the secure vault. Consider the previous version of the secretID ‘S1’ as secretID ‘S0’ associated with certificate pair (Pub-0, Pri-0). The stage identifier of the certificate pair (Pub-0, Pri-0) is “previous”. Next, based on a preconfigured rotation schedule or based on a user request, the serverless function may be triggered to rotate or renew the digital certificate described by the pair (Pub-1, Pri-1). The serverless function may generate a CSR along with a new private key, say Pri-2 and transmit the same to the Certificate Authority (CA). The CA may then issue a new digital certificate, let’s say it is Pub-2. The new issued digital certificate Pub-2 and the new private key Pri-2 may now be stored in the secure vault with “pending” stage identifier using the secretID ‘S2’. Thereafter, the serverless function may initiate a connectivity test to check if the new certificate pair (Pub-2, Pri-2) is working properly. After a successful connectivity test, the serverless function may update the stage identifier of the new certificate pair to “current” and may also update the stage identifier of the certificate pair (Pub-1, Pri-1) from “current” to “previous”. The certificate pair (Pub-0-Pri-0) may now be discarded by the serverless function. The secretID ‘S2’ associated with new certificate pair (Pub-2, Pri-2) with “current” stage identifier may now be returned by secure vault to serve a request. In a scenario where the connectivity test fails, that is when the new certificate pair (Pub-2, Pri-2) did not work properly, the new certificate pair may be discarded and the stage identifiers associated with the pair (Pub-1, Pri-1) and (Pub-0, Pri-0) may be retained as “current” and “previous” respectively. The above description of the example may also be illustrated as shown in FIG. 6 as options 600.

The method 400 thereafter terminates after performing step S412.

The method 400 may be a fully automated process with no human involvement in the entire process. The method 400 ensures high availability, security, and reliability for digital certificate management in cloud-native environments.

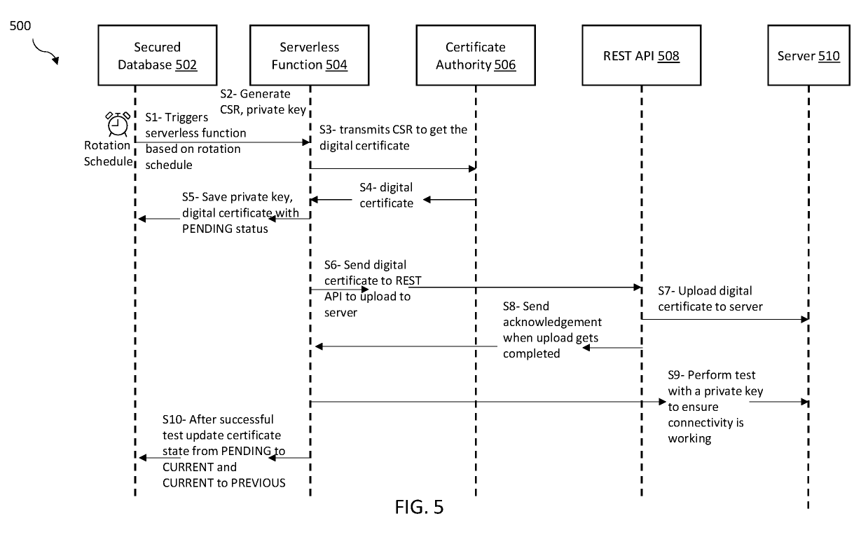

Referring to FIG. 5, a sequence diagram 500 of an exemplary system for automating rotation of a digital certificate in a cloud-native environment using a serverless function 504 is disclosed, in accordance with an exemplary embodiment of the present disclosure. The exemplary system may include a secure vault 502, the serverless function 504, a Certificate Authority (CA) 506, a REST API 508, and a server 510. In an exemplary implementation, the secure vault 502, the serverless function 504, the Certificate Authority (CA) 506, the REST API 508, and the server 510 are similar to those mentioned with respect to FIG. 4. In addition, the exemplary system may perform the method 400 of FIG. 4. The secure vault 502, the serverless function 504, a Certificate Authority (CA) 506, a REST API 508, and the server 510 may all be different/remote entities such that communications as described herein are exchanged between these remote entities.

The sequence diagram 500 may include a series of steps (S1-S10) involving the above-mentioned entities such as the secure vault 502, the serverless function 504, the Certificate Authority (CA) 506, the REST API 508, and the server 510.

At step S1, the serverless function 504 is triggered. In an exemplary implementation, the serverless function 504 may be triggered based on a preconfigured rotation schedule or based on an on-demand request by a user. The preconfigured rotation schedule may refer to a preconfigured timeline or timetable that determines when the serverless function 504 for rotating the digital certificate (or certificate) should be triggered. In an exemplary implementation, the rotation schedule may be stored in the secure vault 502 and specifies when actions like generating new certificate signing requests, issuing digital certificates, uploading digital certificates, performing connectivity tests, and updating stage identifiers should occur. For example, let us assume there is a cloud-based web service that uses a digital certificate (for example, a secure sockets layer (SSL) certificate) to ensure secure communication between clients and server. The SSL certificate may have a validity period (e.g., 1 year), which may ensure that the SSL certificate is rotated (replaced or renewed) before it expires. In this scenario, a rotation schedule may be configured in the secure vault 502. The rotation schedule may be of 6 months, 7 months, etc., to ensure that fresh certificate is available well before the SSL certificate expires (after 1 year). The rotation schedule may specify a date/time (e.g., every 1st of January and July at midnight) or a frequency (e.g., every 180 days) to rotate/replace the digital certificate. In this example, the rotation schedule may be set to trigger the serverless function 504 on January 1st and July 1st of every year. Thus, on January 1st, the secure vault 502 may check the rotation schedule and may trigger the serverless function (504).

Once the serverless function 504 gets triggered, the serverless function 504, at step S2, may generate a certificate signing request (CSR) and an associated private key. The private key may be a part of asymmetric encryption. The private key may be used to digitally sign the digital certificate or decrypt data that was encrypted with a corresponding public key.

Further, at step S3, the serverless function 504 may transmit the CSR to the CA 506. Based on the CSR, the CA 506, at step S4, may issue the digital certificate and send it back to the serverless function 504. The serverless function 504, at step S5, may save the issued digital certificate and its associated private key tagged with a stage identifier as “pending” at the secure vault 502 (as also explained in FIG. 4).

Furthermore, at step S6, the serverless function 504 may send the issued digital certificate to the REST API 508 to upload to the server 510. At step S7, the REST API 508 may upload the issued digital certificate to the server 510 (as also explained in FG. 4).

At step S8, the REST API 508 may send acknowledgement to the serverless function 504 when the issued digital certificate is uploaded at the server 510 successfully.

At step S9, the serverless function 504 may perform a connectivity test to ensure connectivity of the issued digital certificate and the private key with the server 510. Once the connectivity test is successful, the stage identifier of the issued digital certificate and its associated private key may be updated to "current" or another relevant stage, indicating that the issued digital certificate is now active, verified, and ready for use. The successful connectivity test may include receiving a status code (e.g., 200 http status code) from the server which implies that the issued digital certificate and the associated private key are working correctly.

At step S10, after the successful connectivity test, the serverless function 504 may update the stage identifier of the issued digital certificate and its associated private key from “pending” stage to “current” stage (as also explained with respect to FIG. 4). If any issues are found (e.g., missing files, failed verification, etc.), the issued digital certificate and its associated private key may be discarded.

Further, along with updating the stage identifier of the issued digital certificate and its associated private key from “pending” to “current”, the serverless function 504 may be configured to update the stage identifier of an existing digital certificate and an existing associated private key to a “previous” stage. The “previous” stage identifier may describe a previous version of the digital certificate and its associated private key and may be kept along with the newly issued digital certificate and its associated private key in the secure vault. If the connectivity test fails for the newly issued digital certificate and its associated private key, then the serverless function 504 may discard the newly issued digital certificate and its associated private key. In such a scenario, the previous version of the digital certificate and its associated private key may be retained as the “current” pair of certificates.

It will be appreciated by the person skilled in the art that the disclosed method offers an intelligent solution for automating rotation of the digital certificate in the cloud-native environment using the serverless function.

The present application provides several advantages as given below. The present disclosure provides a method for automating rotation of digital certificates (such as certificates) in a secure, cloud-native environment using serverless function. The method may involve creating a signing request, retrieving the signed certificate, storing the certificate in a secure vault, and testing the certificate’s functionality by uploading it to a server. The method may ensure the certificate is properly rotated and validated through automated stages, which may be tracked with a stage identifier. The method may ensure that manual tasks related to generating CSR and private key, obtaining CA signatures and getting the public certificate, uploading and testing the certificate and storing the private key and the public certificate in a secure vault are automated which reduces substantial human effort in repeating the above tasks annually for each certificate before the certificate expires. The method may provide flexible and fully automated process, ensuring high availability, security, and reliability for digital certificate management in cloud environments. Further, the method may avoid the risk associated with private key getting compromised by automating the generation and storing of the private key in secure vault. Furthermore, using serverless functions, the method may significantly reduce operational costs by eliminating the need for dedicated servers and allowing the user to pay only for actual usage. For instance, if a task, such as rotating a certificate, only needs to be performed once a year, leveraging serverless architecture may minimize expenses. On cloud platforms (like Google Cloud, Microsoft Azure, AWS, etc.), users often receive a generous number of free executions under the free tier, which means such tasks may be performed at little to no cost, further optimizing resource efficiency and reducing overhead. Also, the serverless function may automatically scale to handle varying loads, ensuring that the process remains efficient regardless of demand.

Although the present application has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the present application has been described with reference to particular means, materials, and embodiments, the present application is not intended to be limited to the particulars disclosed; rather the present application extends to all functionally equivalent structures, methods, and uses such as are within the scope of the appended claims.

For example, while the computer-readable medium may be described as a single medium, the term “computer-readable medium” may include a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may include a non-transitory computer-readable medium or media and/or include a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present application, a non-transitory computer-readable storage medium storing instructions to a non-transitory computer-readable storage medium storing instructions for automating rotation of a digital certificate in a cloud-native environment using a serverless function is disclosed. The instructions include executable code which, when executed by a processor 104, may cause the processor 104 to generate a certificate signing request and an associated private key; transmit the certificate signing request to a Certificate Authority (CA) for issuing the digital certificate; retrieve the digital certificate from the CA based on the certificate signing request; store the digital certificate and the associated private key tagged with a stage identifier at a secure vault; upload the digital certificate on a server for performing a connectivity test using the associated private key; and update the stage identifier for the digital certificate and the associated private key based on a successful connectivity test.

Although the present application describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the present application may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for automating rotation of a digital certificate in a cloud-native environment using a serverless function, the method comprising:
generating a certificate signing request and an associated private key;
transmitting the certificate signing request to a Certificate Authority (CA) for issuing the digital certificate associated with the certificate signing request;
retrieving the issued digital certificate from the CA based on the certificate signing request;
storing the issued digital certificate and the associated private key tagged with a stage identifier in a secure vault;
uploading the issued digital certificate on a server for performing a connectivity test using the associated private key; and
updating the stage identifier for the issued digital certificate and the associated private key based on a successful connectivity test.

2. The method as claimed in claim 1, wherein the serverless function is triggered based on a preconfigured rotation schedule and an on-demand request.

3. The method as claimed in claim 1, wherein an acknowledgment is received from the server upon successful uploading of the issued digital certificate.

4. The method as claimed in claim 1, wherein the issued digital certificate is uploaded on the server using a REST API.

5. The method as claimed in claim 1, wherein the issued digital certificate and the associated private key stored in the secure vault are tagged with the stage identifier defined with a pending stage.

6. The method as claimed in claim 5, wherein based on the successful connectivity test, the stage identifier of the issued digital certificate and the associated private key stored in the secure vault is updated to from a pending stage a current stage and the stage identifier of an existing digital certificate and an existing associated private key is updated from a current stage to a previous stage.

7. The method as claimed in claim 6, wherein the successful connectivity test comprises receiving a status code from the server to ensure that the issued digital certificate and the associated private key are working correctly.

8. A computing device configured for automating rotation of a digital certificate in a cloud-native environment using a serverless function, the computing device comprising:
a processor;
a memory storing instructions; and
a communication interface coupled to each of the processor and the memory, wherein the processor is programmed to cooperate with the instructions to perform operations comprising:
generate a certificate signing request and an associated private key;
transmit the certificate signing request to a Certificate Authority (CA) for issuing the digital certificate associated with the certificate signing request;
retrieve the issued digital certificate from the CA based on the certificate signing request;
store the issued digital certificate and the associated private key tagged with a stage identifier in a secure vault;
upload the issued digital certificate on a server for performing a connectivity test using the associated private key; and
update the stage identifier for the issued digital certificate and the associated private key based on a successful connectivity test.

9. The computing device as claimed in claim 8, wherein the serverless function is triggered based on a preconfigured rotation schedule and an on demand request.

10. The computing device as claimed in claim 8, wherein an acknowledgment is received from the server upon successful uploading of the issued digital certificate.

11. The computing device as claimed in claim 8, wherein the issued digital certificate is uploaded on the server using a REST API.

12. The computing device as claimed in claim 8, wherein the issued digital certificate and the private key stored in the secure vault are tagged with the stage identifier defined with a pending stage.

13. The computing device as claimed in claim 12, wherein based on the successful connectivity test, the stage identifier of the issued digital certificate and the associated private key stored in the secure vault is updated from the pending stage to a current stage and the stage identifier of an existing digital certificate and an existing associated private key is updated from a current stage to a previous stage.

14. The computing device as claimed in claim 13, wherein the successful connectivity test comprises receiving a status code from the server to ensure that the issued digital certificate and the associated private key are working correctly.

15. A non-transitory computer readable storage medium storing instruction for automating rotation of a digital certificate in a cloud-native environment using a serverless function, the instructions comprising executable code which when executed by a processor, causes the processor to perform operations comprising:
generate a certificate signing request and an associated private key;
transmit the certificate signing request to a Certificate Authority (CA) for issuing the digital certificate associated with the certificate signing request; retrieve the issued digital certificate from the CA based on the certificate signing request;
store the issued digital certificate and the associated private key tagged with a stage identifier in a secure vault;
upload the issued digital certificate on a server for performing a connectivity test using the associated private key; and
update the stage identifier for the issued digital certificate and the associated private key based on a successful connectivity test

16. The storage medium as claimed in claim 15, wherein the serverless function is triggered based on a preconfigured rotation schedule and an on-demand request.

17. The storage medium as claimed in claim 15, wherein an acknowledgment is received from the server upon successful uploading of the issued digital certificate.

18. The storage medium as claimed in claim 15, wherein the issued digital certificate and the associated private key stored in the secure vault are tagged with the stage identifier defined with a pending stage.

19. The storage medium as claimed in claim 18, wherein based on the successful connectivity test, the stage identifier of the issued digital certificate and the associated private key stored in the secure vault is updated from the pending stage to a current stage and the stage identifier of an existing digital certificate and an existing associated private key is updated from the current stage to a previous stage.

20. The storage medium as claimed in claim 19, wherein the successful connectivity test comprises receiving a status code from the server to ensure that the issued digital certificate and the associated private key are working correctly.
